(19) United States
(12) Patent Application Publication
(10) Pub. No.: US 2014/0223300 A1
(43) Pub. Date: Aug. 7, 2014

(54) REMOTE ASSISTANCE METHOD, SYSTEM AND TERMINAL

(71) Applicant: TENCENT TECHNOLOGY (SHENZHEN) COMPANY LIMITED, Shenzhen city (CN)

(72) Inventors: Zhongnan LI, Shenzhen city (CN); Sijian ZHANG, Shenzhen city (CN)

(73) Assignee: TENCENT TECHNOLOGY (SHENZHEN) COMPANY LIMITED, Shenzhen city (CN)

(21) Appl. No.: 14/252,199

(22) Filed: Apr. 14, 2014

Related U.S. Application Data
(63) Continuation of application No. PCT/CN2013/070524, filed on Jan. 16, 2013.

(30) Foreign Application Priority Data
Feb. 22, 2012 (CN) 201210040505.1

(51) Int. Cl. H04L 29/06; G06F 3/0481; H04L 29/08

(52) U.S. Cl. CPC H04L 65/403; H04L 67/025; G06F 3/0481
USPC 715/708

(57) ABSTRACT

An implementation of the present invention provides a remote assistance method, system and terminal. The method comprises: establishing a connection between an assisted terminal and an assisting terminal through a communication protocol; designating a window that needs assistance and sending a screenshot of the window to the assisting terminal by the assisted terminal; displaying the screenshot of the window, executing an assistance operation on the screenshot of the window, and sending assistance operation information corresponding to the assistance operation to the assisted terminal by the assisting terminal; executing the assistance operation specified by the assisting terminal on the window that needs assistance by the assisted terminal, according to the assistance operation information. The implementation of the present invention improves operation accuracy and protects user's privacy.

### CROSS REFERENCE TO RELATED APPLICATIONS

This application is a continuation application of PCT Application PCT/CN2013/070524 filed on Jan. 16, 2013 which claims priority from Chinese Patent Application No. 201210040505.1 filed on Feb. 22, 2012. The aforementioned patent applications are hereby incorporated by reference in their entirety.

### FIELD OF THE INVENTION

The present invention relates to the technical field of computer applications, and more specifically, to a remote assistance method, system and terminal.

### BACKGROUND

As the rapid development of the computer technology and network technology, Internet is playing a more and more important role in people's daily lives, learning and works.

Remote assistance is a technology in which one terminal (the controlling client, Remote/client, an assisting party) assists another terminal (the controlled client, Host/server client, an assisted party) remotely on the network. The remote assistance technology in terminals began in the disk operation system (DOS) era. The remote assistance generally supports the following network modes: LAN, WAN, dial-up mode, Internet mode, etc. In addition, some remote control software also supports controlling the remote apparatus through ports such as serial ports, parallel ports, infrared ports.

In the remote assistance applications of the prior art, most of them are similar to the remote desktop connection function built in the Windows operation system. By establishing a connection between two terminals (A and B), one terminal (A) can view or control the other terminal (B).

In the current remote assistance applications, the default assistance object is the full screen desktop of the assisted terminal. However, in reality, the assisted terminal does not necessarily need assistance for the full screen desktop. In many circumstances, only a certain function or a certain window of a certain program needs assistance for an encountered problem. It is not efficient to display a full screen desktop to the assisting party, and it is difficult for the assisting party to understand which function or which program window on the desktop needs assistance, and it is likely to incur misoperations.

Also, because the assisting terminal needs to display the entire desktop of the assisted terminal, when the screen resolution of the assisting terminal is far less than the screen resolution of the assisted terminal, the display window will show a scrollbar. This is inconvenient for the assisting party to view the desktop of the assisted terminal and to operate the desktop. If the display resolution of the desktop of the assisted terminal is compressed, the display effect would be very unclear.

Furthermore, the assisted party may have some private files or application programs that are not expected to be seen by the assisting party, and therefore, the assisted party often does not want to expose the entire desktop to the assisting party, because the assisted party's privacy might be exposed if the entire desktop is displayed to the assisting party.

### SUMMARY OF THE INVENTION

An implementation of the present invention provides a remote assistance method for improving operation accuracy and protecting privacy.

An implementation of the present invention also provides a remote assistance system for improving operation accuracy and protecting privacy.

An implementation of the present invention also provides a remote assistance terminal for improving operation accuracy and protecting privacy.

The details of the implementations of the present invention are as follows:

A remote assistance method is provided, comprising:

establishing a connection between an assisted terminal and an assisting terminal through a communication protocol;

designating a window that needs assistance and sending a screenshot of the window to the assisting terminal by the assisted terminal;

displaying the screenshot of the window, executing an assistance operation on the screenshot of the window, and sending assistance operation information corresponding to the assistance operation to the assisted terminal by the assisting terminal; and

executing the assistance operation specified by the assisting terminal on the window by the assisted terminal, according to the assistance operation information.

A remote assistance system is provided, comprising an assisting terminal and an assisted terminal, the assisted terminal and assisting terminal establishing a connection through a communication protocol, wherein:

the assisted terminal is configured to designate a window that needs assistance, send a screenshot of the window to the assisting terminal, and execute an assistance operation specified by the assisting terminal on the window that needs assistance, according to assistance operation information sent by the assisting terminal;

the assisting terminal is configured to display the screenshot of the window, execute the assistance operation on the screenshot of the window, and send the assistance operation information corresponding to the assistance operation to the assisted terminal.

A remote assistance method is provided, comprising:

establishing a connection between an assisted terminal and an assisting terminal through a communication protocol;

designating a window that needs assistance and sending a screenshot of the window to the assisting terminal by the assisted terminal;

receiving, by the assisted terminal, assistance operation information sent by the assisting terminal, wherein the assistance operation information corresponds to an assistance operation executed by the assisting terminal on the screenshot of the window;

executing the assistance operation specified by the assisting terminal on the window by the assisted terminal, according to the assistance operation information.

A remote assistance terminal is provided, comprising a connection module, a window designating module, a transceiver module and a processing module, wherein,

the connection module is configured to establish a connection with an assisting terminal through a communication protocol;

the window designating module is configured to designate a window that needs assistance, and send a screenshot of the window to the transceiver module;

the transceiver module is configured to send the screenshot of the window to the assisting terminal, and receive assistance operation information sent by the assisting terminal, wherein the assistance operation information corresponds to an assistance operation executed by the assisting terminal on the screenshot of the window;

the processing module is configured to execute the assistance operation specified by the assisting terminal on the window, according to the assistance operation information.

It can be seen from the above-mentioned technical solutions that, in the implementations of the present invention, an assisted terminal and an assisting terminal firstly establish a connection through a communication protocol, and then the assisted terminal designates a window that needs assistance, and the assisting terminal displays a screenshot of the window, executes an assistance operation on the screenshot of the window, and sends assistance operation information corresponding to the assistance operation to the assisted terminal. Finally, the assisted terminal executes the assistance operation specified by the assisting terminal on the window, according to the assistance operation information. It can be seen that, according to the implementations of the present invention, the assisting terminal may precisely and intuitively know its own task and the object that needs assistance. There is no need to look for the window that needs assistance under the full screen remote assistance mode, as in the prior art, thereby avoiding looking for the actual object that needs assistance and misoperation. Moreover, after the window that needs remote assistance is designated, the assisting party can only see the assistance object designated by the assisted terminal, and the content unrelated to the assistance process on the desktop of the assisted terminal will not be seen by the assisted party; by this configuration, it is possible to protect the privacy of the assisted party well. Therefore, the implementations of the present invention could improve the operation accuracy and protect privacy.

### DESCRIPTION OF THE DRAWINGS

FIG. 1 is a flow chart of a remote assistance method according to an implementation of the present invention;

FIG. 2 is a schematic diagram for selecting a remote assistance mode according to an implementation of the present invention;

FIG. 3 is a schematic diagram of a desktop of an assisted party under a full screen remote assistance mode according to an implementation of the present invention;

FIG. 4 is a window-on-top schematic diagram for selecting a window under a single window remote assistance mode according to an implementation of the present invention;

FIG. 5 is a schematic diagram for switching among the windows under the single window remote assistance mode according to an implementation of the present invention;

FIG. 6 is a schematic diagram of the window display of the assisted party under the single window remote assistance mode according to an implementation of the present invention;

FIG. 7 is a schematic diagram of the window display of the assisting party under the single window remote assistance mode according to an implementation of the present invention;

FIG. 8 is a flow schematic diagram that shows switching from the full screen remote assistance mode to the single window remote assistance mode according to an implementation of the present invention;

FIG. 9 is a flow schematic diagram that shows switching from the single window remote assistance mode to the full screen remote assistance mode according to an implementation of the present invention;

FIG. 10 is a structural diagram of a remote assistance system according to an implementation of the present invention;

FIG. 11 is a flow chart of a remote assistance method according to another embodiment of the present invention;

FIG. 12 is a structural diagram of a remote assistance terminal according to an implementation of the present invention.

### DETAILED DESCRIPTION

To make the technical solutions and advantages of the present invention more clear, further detailed description of the present invention will be given based on the accompanied drawings.

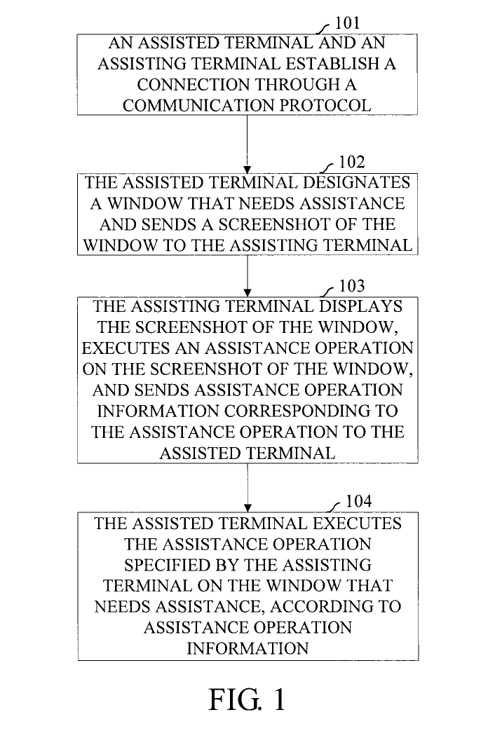

FIG. 1 is a flow chart of a remote assistance method according to an implementation of the present invention.

As shown in FIG. 1, the method comprising:

Step 101: establishing a connection between an assisted terminal and an assisting terminal through a communication protocol.

Here, the assisted terminal and the assisting terminal generally may use protocols such as Network Basic Input/Output System Extended User Interface (NETBEUI), Network Basic Input/Output System (NETBIOS), Internet Packet Exchange (IPX)/Sequenced Packet Exchange (SPX), Transmission Control Protocol (TCP)/Internet Protocol (IP), to realize remote control. Moreover, as the development of the network technology, the assisting terminal may also control the assisted terminal through web pages with Java technology, and this implementation may realize remote control under different operation systems. Preferably, the assisted terminal and the assisting terminal may also establish the connection through an instant messaging mode.

Step 102: designating a window that needs assistance and sending a screenshot of the window to the assisting terminal by the assisted terminal.

Here, the assisted terminal may designate the window that needs assistance and send the screenshot of the window to the assisting terminal after the assisted terminal and the assisting terminal have established the connection. Alternatively, the assisting terminal may designate the window that needs assistance in advance before the assisted terminal and the assisting terminal have established the connection, and send the screenshot of the window to the assisting terminal after the assisted terminal and the assisting terminal have established the connection. Preferably, before the screenshot of the window is sent to the assisting terminal, the screenshot is compressed to facilitate information transmission.

Step 103: displaying the screenshot of the window, executing an assistance operation on the screenshot of the window, and sending assistance operation information corresponding to the assistance operation to the assisted terminal by the assisting terminal.

Here, the assisting terminal firstly decompresses the compressed package which includes the screenshot sent from the assisted terminal, and displays the screenshot of the window, and then executes the corresponding assistance operation on the screenshot of the window, and then sends assistance operation information corresponding to the assistance operation to the assisted terminal.

Normally, the assistance operation of the assisting terminal mainly includes a mouse operation and/or a keyboard operation on the screenshot of the window. The mouse operation and/or the keyboard operation may be sent to the assisted terminal by corresponding mouse moving coordinate information or keyboard messages.

Step 104: executing the assistance operation of the assisting terminal on the window that needs assistance by the assisted terminal, according to the assistance operation information.

Here, after the assisted terminal receives the assistance operation information corresponding to the mouse operation and/or the keyboard operation, it may use an Application Programming Interface (API) function to execute the mouse operation and/or the keyboard operation on a local window, as if the assisting terminal is using its local mouse and/or keyboard operation.

In one embodiment, the method further comprises:

setting a window switching condition by the assisted terminal; and when the window switching condition is satisfied, re-selecting a window by the assisted terminal, and designating the re-selected window as the window that needs assistance. In this way, the assistance of switching among the windows that need assistance may be realized according to the window switching condition.

For example, it is assumed that the current window that needs assistance is the full screen desktop, and if the assisted terminal expects a window which is used by a certain software A to be assisted, the window switching condition may be set as follows: when the window which is used by software A has a problem, the window being used would be designated as the window that needs assistance. Hereafter, if the window which is used by software A has a problem, it is considered that the window switching condition is satisfied, and the window that needs assistance may be manually or automatically re-selected, and the window which is used by software A is designated as the window that needs assistance, thereby realizing switching of the window that needs assistance from the full screen desktop to the actual specific window.

Similarly, switching of the window that needs assistance from the actual specific window to the full screen desktop may be realized according to the window switching condition.

When the window switching condition indicates that a certain specific window needs assistance, the user may select a single window to be assisted after launching a full screen remote assistance. Moreover, the user may also select a single window to be remotely assisted before launching a full screen remote assistance.

Next, the implementation of the present invention will be elaborated in details, using a specific example in which the assisted terminal and the assisting terminal establish the connection by using an instant messaging mode. Those skilled in the art may appreciate that this elaboration is merely exemplary, and it is not intended to limit the protection scope of the present invention.

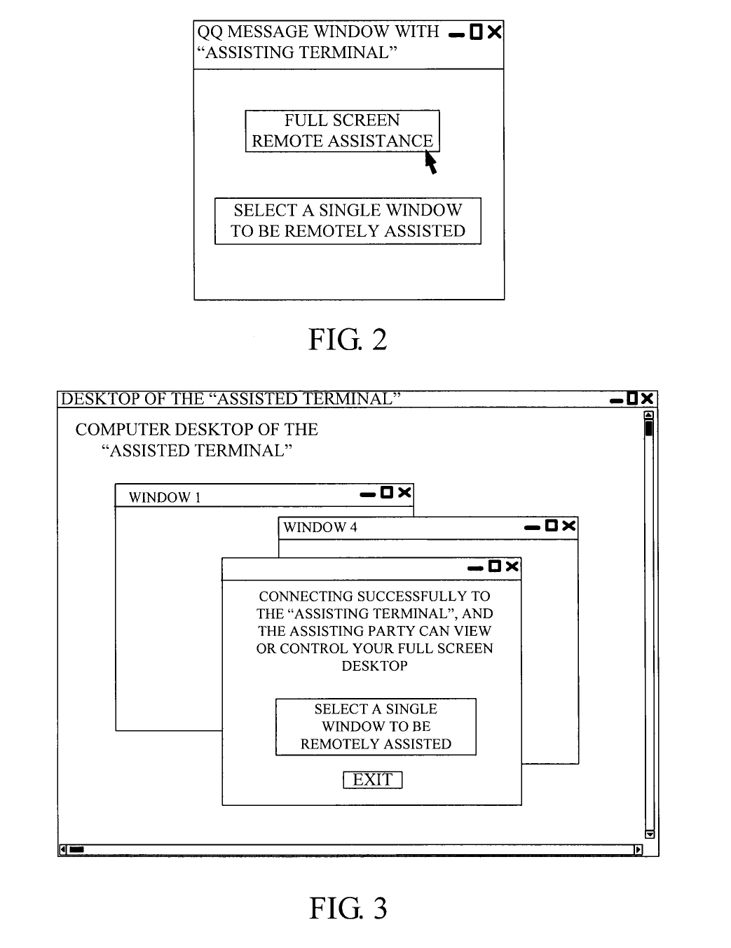

FIG. 2 is a schematic diagram for selecting a remote assistance mode according to an implementation of the present invention.

As can be seen from FIG. 2, a user as the assisted party firstly opens a window of instant messaging chat with the assisting party. At this time, if the full screen remote assistance button is clicked, a full screen remote assistance request is sent to the assisting terminal. If the single window remote assistance button is clicked, a single window remote assistance request is sent to the assisting terminal.

After the assisting terminal accepts the remote assistance request of the assisted terminal, the assisted terminal sends a feedback to the assisting terminal showing that the connection is successful, and prompts to allow the other party to view the single window or remotely control the full screen desktop. FIG. 3 is a schematic diagram of the desktop of the assisting terminal under a full screen remote assistance mode according to an implementation of the present invention. At this time, the entire desktop of the assisted terminal is displayed on the screen of the assisting terminal.

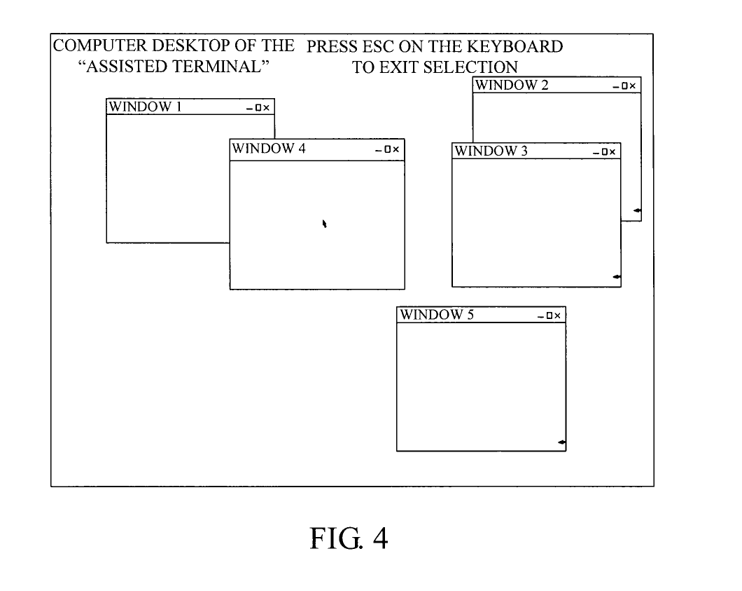

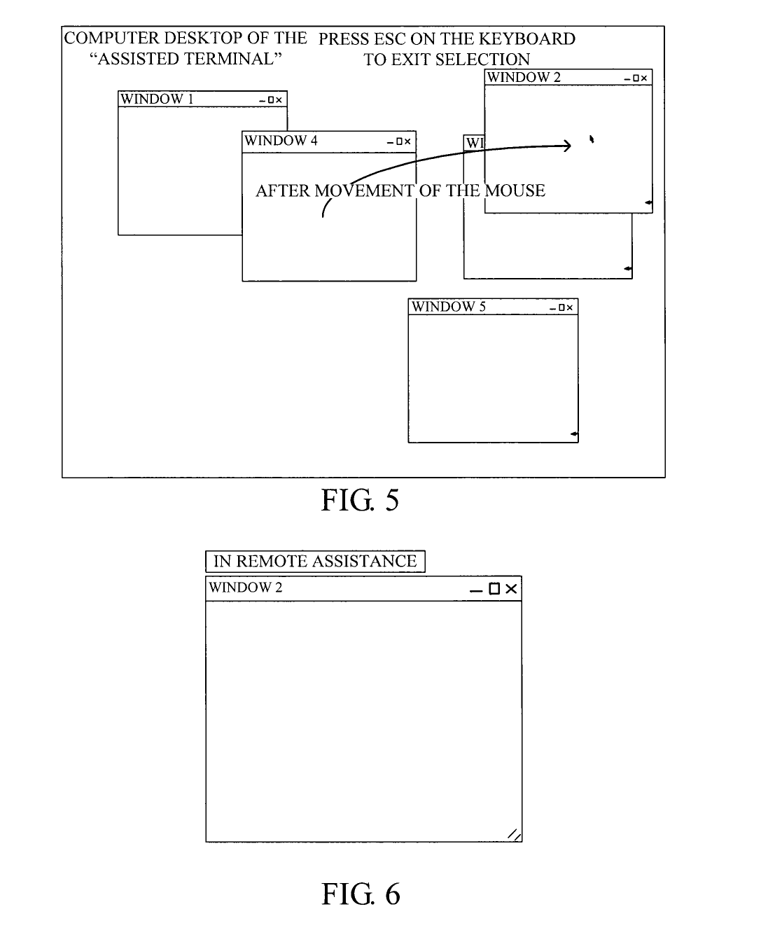

FIG. 4 is a window-on-top schematic diagram for selecting a window under the single window remote assistance mode according to an implementation of the present invention. FIG. 5 is a schematic diagram for switching among the windows under the single window remote assistance mode according to an implementation of the present invention.

A mouse may be moved (mouseover) to a window that needs assistance, and when the mouse is moved to a window that is not window on top, the window automatically placed on top. Moreover, after clicking a certain window, the window will be selected successfully. As can be seen from FIG. 4 and FIG. 5, when the mouse is moved to window 4, window 4 is automatically placed on top, and after the mouse is clicked on window 2, window 2 is successfully selected as the window that needs assistance. Preferably, pressing ESC button on the keyboard at any time may exit the process of selecting the window that needs assistance.

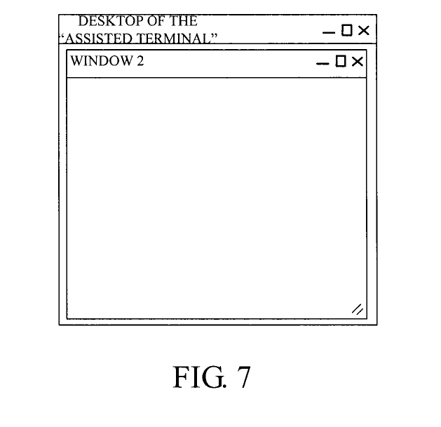

FIG. 6 is a schematic diagram of a window display of the assisted terminal under the single window remote assistance mode according to an implementation of the present invention. FIG. 7 is a schematic diagram of a window display of the assisting terminal under the single window remote assistance mode according to an implementation of the present invention.

As shown in FIG. 6, after the assisted terminal successfully selects window 2 as the window that needs assistance, the screenshot of window 2 is sent to the assisting terminal, and at this time, only window 2 is displayed at the assisting terminal. In this case, the assisting terminal executing remote assistance may execute the assistance operation on window 2 on the screenshot of the window, and send the assistance operation information corresponding to the assistance operation to the assisted terminal. As shown in FIG. 7, after window 2 is clicked and successfully selected, the assisted terminal may prompt that window 2 is being remotely assisted.

In the above-mentioned process, the user may firstly send a full screen remote assistance request, and then select a single window to send a single window remote assistance request. Optionally, the user may also send a remote assistance request for a single window, and then send a full screen remote assistance request, if needed. The user may switch between the full screen remote assistance and the single window remote assistance in a convenient manner.

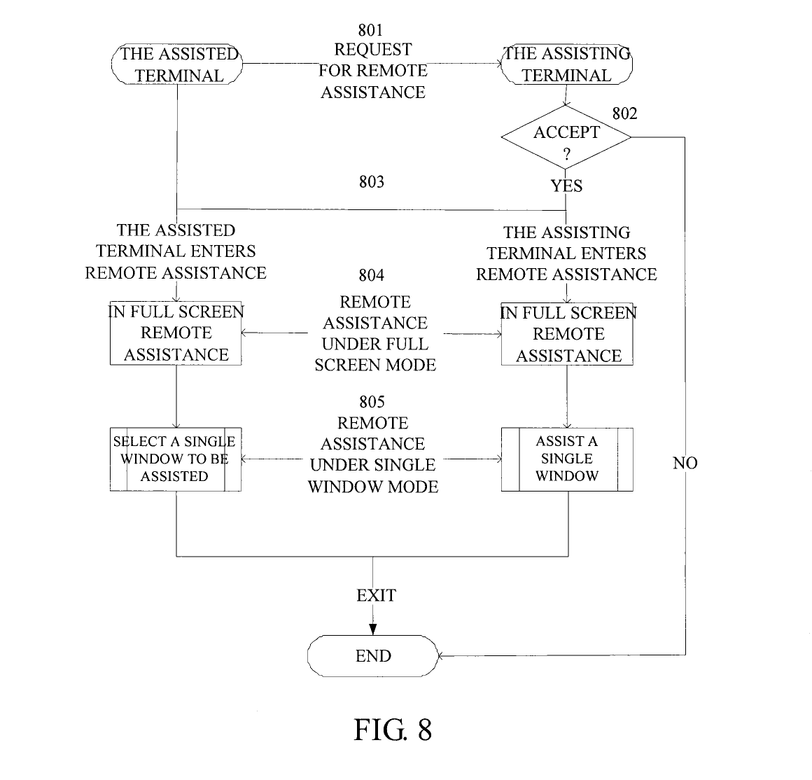

FIG. 8 is a flow schematic diagram that shows switching from a full screen remote assistance mode to a single window remote assistance mode according to an implementation of the present invention.

As shown in FIG. 8, the method comprising:

Step 801: establishing a connection with an assisting terminal through a communication protocol and sending a remote assistance request to the assisting terminal by an assisted terminal.

Step 802: determining whether to accept the remote assistance request by the assisting terminal, and if yes, step 803 and the subsequent steps are executed, and if no, the process is exited.

Step 803-Step 804: executing a full screen remote assistance by the assisting terminal and the assisted terminal.

At this time, after the two parties reach a protocol to establish the connection, the full screen desktop of the assisted terminal is taken as a screenshot in real time, and is compressed, packaged and sent to the assisting terminal. The assisting terminal decompresses the compressed package and displays the full screen desktop screenshot and executes the assistance operation, and then the assistance operation information is compressed, packaged and sent back to the assisted terminal; at this time, the compressed package which is sent back records the positions and actions of the mouse on the full screen desktop screenshot, and the actions of the keyboard of the assisting terminal. After receipt by the assisted terminal, the compressed package is decompressed to display the full screen desktop screenshot, and meanwhile the assisted terminal uses the API function to simulate the actions of the mouse and the keyboard of the assisting terminal on the full screen desktop screenshot.

Step 805: after selecting a single window to be remotely assisted by the assisted terminal, executing a single window remote assistance by the assisting terminal and the assisted terminal.

At this time, the assisted terminal firstly selects a certain window as the window that needs assistance, and takes a screenshot of the window that needs assistance in real time, and the screenshots are compressed, packaged and sent to the assisting terminal. The assisting terminal decompresses the compressed package, displays the screenshot of the window that needs assistance, and executes an assistance operation, and then the assisting terminal compresses, packages and sends the assistance operation information back to the assisted terminal, and at this time, the compressed package which is sent back records the positions and actions of the mouse on the screenshot of the window that needs assistance and the actions of the keyboard of the assisting terminal. After receipt by the assisted terminal, the compressed package is decompressed to display the screenshot of the window that needs assistance, and meanwhile the assisted terminal uses the API function to simulate the actions of the mouse and keyboard of the assisting terminal on the screenshot of the window that needs assistance.

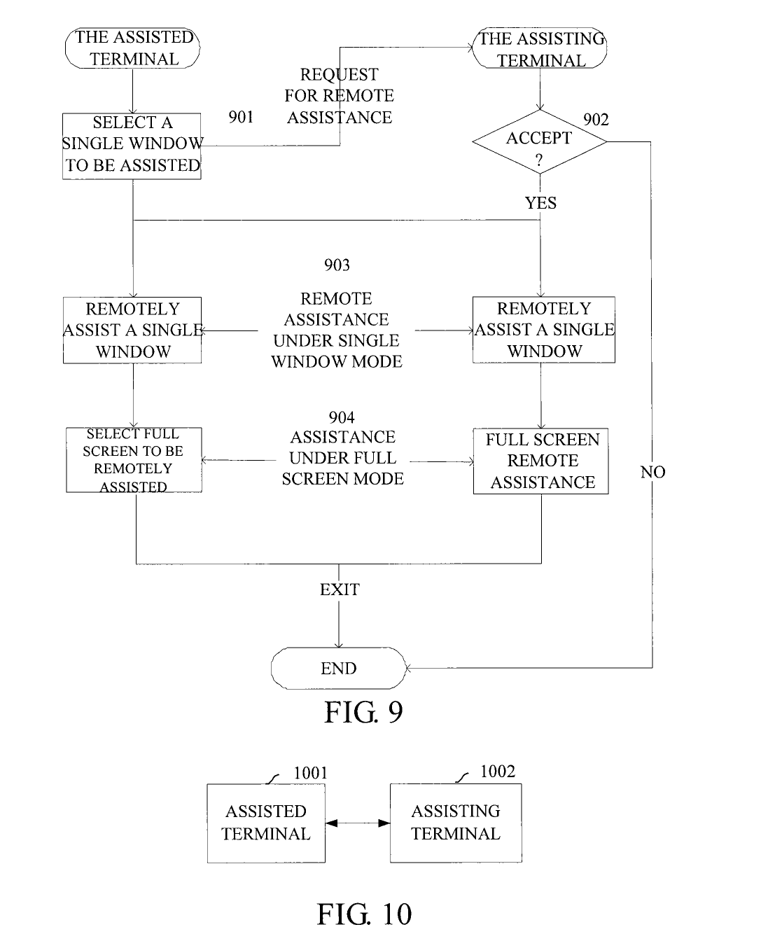

FIG. 9 is a flow schematic diagram that shows switching from a single window remote assistance mode to a full screen remote assistance mode according to an implementation of the present invention.

As shown in FIG. 9, the method comprising:

Step 901: selecting a single window as the window that needs assistance and sending a remote assistance request to an assisting terminal by an assisted terminal.

Here, the assisted terminal and the assisting terminal establish a connection through a communication protocol, and then the assisted terminal selects a certain single window as the window that needs assistance, and sends a remote assistance request to the assisting terminal through the connection.

Step 902: determining whether to accept the remote assistance request by the assisting terminal, and if yes, step 903 and the subsequent steps are executed, and if no, the process is exited.

Step 903: executing a single window remote assistance by the assisting terminal and the assisted terminal.

Here, the assisted terminal takes a screenshot of the window that needs assistance selected in Step 901 in real time, and the screenshot is compressed, packaged and sent to the assisting terminal. The assisting terminal decompresses the compressed package, displays the screenshot of the window that needs assistance, and executes assistance operation on the screenshot of the window that needs assistance, and then the assistance operation information is compressed, packaged and sent back to the assisted terminal, and at this time, the compressed package which is sent back records the positions and actions of the mouse on the screenshot of the window that needs assistance, and the actions of the keyboard of the assisting terminal. After the compressed package is received by the assisted terminal, it is decompressed to display the screenshot of the window that needs assistance, and meanwhile the assisted terminal uses the API function to simulate the actions of the mouse and keyboard of the assisting terminal on the screenshot of the window that needs assistance.

Step 904: selecting to execute a full screen remote assistance by the assisted terminal, and executing the full screen remote assistance by the assisting terminal and the assisted terminal.

Here, the assisted terminal determines to execute full screen assistance by the assisting terminal, takes a screenshot of the full screen desktop of the assisted terminal itself in real time, and the screenshot is compressed, packaged and sent to the assisting terminal. The assisting terminal decompresses the compressed package, displays the full screen desktop screenshot, and executes an assistance operation on the full screen desktop screenshot, and then the assistance operation information is compressed, packaged and sent back to the assisted terminal, and at this time, the compressed package which is sent back records the positions and actions of the mouse of the assisting terminal on the full screen desktop screenshot, and the actions of the keyboard. After the compressed package is received by the assisted terminal, it is decompressed to display the full screen desktop screenshot, and meanwhile the assisted terminal uses the API function to simulate the actions of the mouse and keyboard of the assisting terminal on the full screen desktop screenshot.

Based on above-mentioned detailed analysis, an implementation of the present invention also provides a remote assistance system. FIG. 10 is a structural diagram of the remote assistance system according to an implementation of the present invention.

As shown in FIG. 10, the system includes an assisting terminal 1001 and an assisted terminal 1002, wherein the assisted terminal 1001 and the assisting terminal 1002 establish a connection through a communication protocol.

The assisted terminal 1001 is configured to designate a window that needs assistance, send a screenshot of the window to the assisting terminal 1002, and execute an assistance operation specified by the assisting terminal 1002 on the window that needs assistance, according to assistance operation information sent by the assisting terminal 1002.

The assisting terminal 1002 is configured to display the screenshot of the window, execute an assistance operation on the screenshot of the window, and send assistance operation information corresponding to the assistance operation to the assisted terminal 1001.

In one embodiment, the assisted terminal 1001 and the assisting terminal 1002 may establish the connection through protocols such as NETBIOS protocol, NETBEUI protocol, IPX/SPX protocol or TCP/IP. Moreover, the assisted terminal 1001 may further set a window switching condition, wherein when the window switching condition is satisfied, a window is re-selected and the re-selected window is designated as the window that needs assistance. For example, the assisted terminal 1001 may re-select to switch to the full screen desktop, and designate the full screen desktop as the window that needs assistance.

In another embodiment, the assisting terminal 1002 is configured to execute a mouse operation and/or a keyboard operation on the screenshot of the window, and send the assistance operation information corresponding to the mouse operation and/or the keyboard operation to the assisted terminal 1001. The assisted terminal 1001 is configured to receive the assistance operation information corresponding to the mouse operation and/or the keyboard operation, and use the API function to execute the mouse operation and/or the keyboard operation on the window.

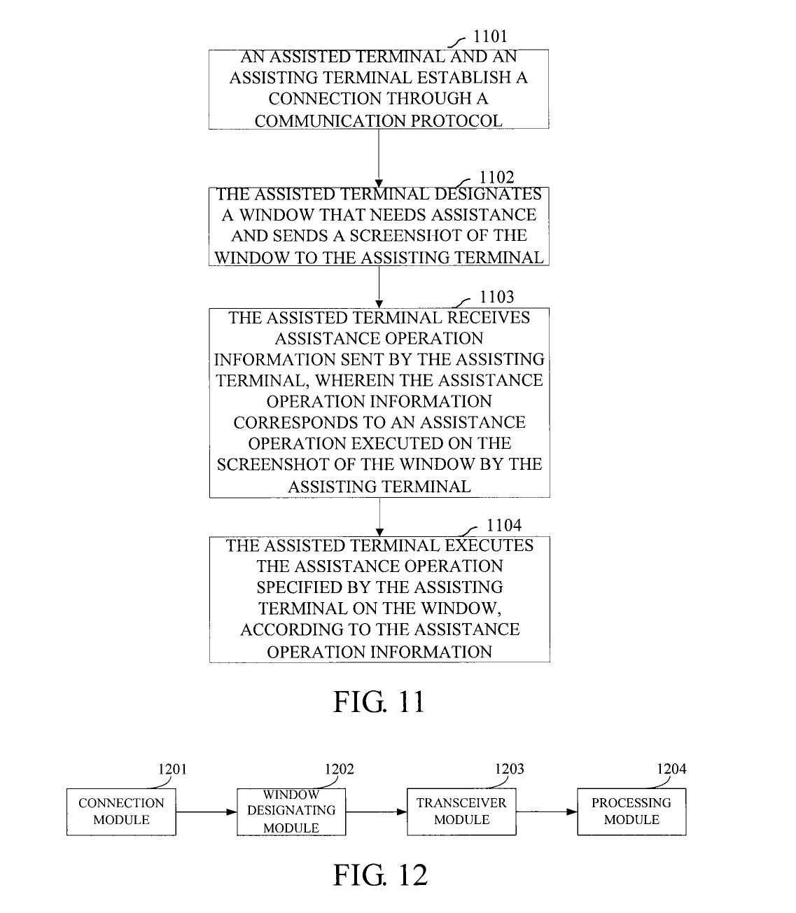

Another implementation of the present invention also provides a remote assistance method, as shown in FIG. 11. FIG. 11 is a flow chart of a remote assistance method according to another implementation of the present invention, the method comprising:

Step 1101: establishing a connection through a communication protocol between an assisted terminal and an assisting terminal;

Step 1102: designating a window that needs assistance and sending a screenshot of the window to the assisting terminal by the assisted terminal;

Step 1103: receiving, by the assisted terminal, assistance operation information sent by the assisting terminal, wherein the assistance operation information corresponds to an assistance operation executed on the screenshot of the window by the assisting terminal;

Step 1104: executing, by the assisted terminal, the assistance operation specified by the assisting terminal on the window, according to the assistance operation information.

In this implementation, the method further comprises:

setting a window switching condition by the assisted terminal; and when the window switching condition is satisfied, selecting a window and designating the selected window as the window that needs assistance by the assisted terminal.

In this implementation, when the assisted terminal selects to switch to the full screen desktop, the full screen desktop is designated as the window that needs assistance.

In this implementation, the assistance operation executed on the screenshot of the window by the assisting terminal includes a mouse operation and/or a keyboard operation, and the assistance operation information corresponds to the mouse operation and/or the keyboard operation. The assisted terminal receives the assistance operation information corresponding to the mouse operation and/or the keyboard operation, and uses the Application Programming Interface (API) function to execute the mouse operation and/or the keyboard operation on the window.

An implementation of the present invention also provides a remote assistance terminal, as shown in FIG. 12. FIG. 12 is a structural diagram of a remote assistance terminal according to an implementation of the present invention, wherein the terminal includes a connection module 1201, a window designating module 1202, a transceiver module 1203, and a processing module 1204.

The connection module 1201 is configured to establish a connection with an assisting terminal through a communication protocol. Further, after the connection is successfully established, the connection module 1201 sends a connection successful message to the window designating module 1202.

The window designating module 1202 is configured to designate a window that needs assistance, and sends a screenshot of the window to the transceiver module 1203. After the window designating module 1202 receives the connection successful message sent by the connection module 1201, it designates the window that needs assistance.

The transceiver module 1203 is configured to send the screenshot of the window to the assisting terminal, and receive assistance operation information sent by the assisting terminal, wherein the assistance operation information corresponds to the assistance operation executed on the screenshot of the window by the assisting terminal.

The processing module 1204 is configured to execute the assistance operation of the assisting terminal on the window according to the assistance operation information.

In this implementation, the terminal further includes a setting module, which is configured to set a window switching condition. The window designating module is configured to select a window when the window switching condition is satisfied, and designate the selected window as the window that needs assistance.

In this implementation, the window designating module is configured to designate the full screen desktop as the window that needs assistance when the assisted terminal selects to switch to the full screen desktop.

In this implementation, the assistance operation executed on the screenshot of the window by the assisting terminal includes a mouse operation and/or a keyboard operation, and the assistance operation information corresponds to the mouse operation and/or the keyboard operation. The transceiver module is configured to receive the assistance operation information corresponding to the mouse operation and/or the keyboard operation, and the processing module is configured to use the Application Programming Interface (API) function to execute the mouse operation and/or the keyboard operation on the window.

The above-mentioned modules are divided based on logic functions, and in practical applications, the function of one module may also be realized by multiple modules, or the functions of multiple modules may be realized by one module. In other embodiments of the present invention, a remote assistance terminal may include other modules. An implementation of the present invention provides another structural schematic diagram of a remote assistance terminal. The remote assistance terminal includes a connection module, a window designating module, a transceiver module, a processing module, a CPU, a memory, a MAC address mapping table and a tunnel encapsulation mapping table, wherein these modules connect with each other through an internal bus. The functions of the connection module, the window designating module, the transceiver module, and the processing module are mainly launched and controlled by the connection module, the window designating module, the transceiver module, and the processing module. However, in practical applications, these functions may also be assisted and realized by other modules, and may be cooperated and realized by multiple modules. For example, it is possible to use the process function of the CPU, read information from the memory, transmit data through the internal bus etc.

The methods and apparatuses provided by the embodiments of the present invention may be realized by hardware, or computer-readable instructions, or the combination of hardware and computer readable instructions. The computer readable instructions used in the present embodiment are stored by multiple processors in a readable storage medium, such as hard disk, CD-ROM, DVD, optical disk, floppy disk, magnetic tape, RAM, ROM or other suitable storage device. Alternatively, at least a part of the computer-readable instructions may be replaced by specific hardware, such as customized integrated circuit, gate array, FPGA, PLD and computers with specific functions etc.

An embodiment of the present invention provides a computer-readable storage medium, which is configured to store instructions causing a computer to execute the methods described herein. Specifically, both of the system and apparatus provided by the present embodiment have a storage medium to store computer-readable program codes, wherein the program codes are used to realize the functions of any of the above-mentioned embodiments, and the system or apparatus (or CPU or MPU) can read and execute the program codes stored in a storage medium.

In this case, reading of the program codes from the storage medium may realize any one of the above-mentioned embodiments, and therefore, the program codes and the storage medium that stores the program codes are part of the technical solution.

The storage medium for providing program codes includes floppy disk, hard disk, magneto-optical disk, optical disk (such as CD-ROM, CD-R, CD-RW, DVD-ROM, DVD-RAM, DVD-RW, DVD+RW), disk, flash memory card, ROM etc. Alternatively, program codes may also be downloaded from a server computer through a communication network.

It should be noted that, for computer executed program codes, at least a part of the operations realized by the program codes may be realized by the operation system that is running on the computer, thereby realizing the technical solution of any one of the above-mentioned embodiments, wherein the computer executes instructions based on the program codes.

Also, the program codes in the storage medium are written into memory, wherein the memory is located in an expansion board which is inserted into the computer, or is located in an expansion unit which is connected to the computer. In the present embodiment, a CPU in the expansion board or expansion unit executes at least a part of the operations according to instructions based on the program codes, thereby realizing the technical solution of any one of the above-mentioned embodiments.

In summary, in the implementations of the present invention, an assisted terminal and an assisting terminal firstly establish a connection through a communication protocol, and then, the assisted terminal designates a window that needs assistance, and the assisting terminal displays a screenshot of the window, executes an assistance operation on the screenshot of the window, and sends assistance operation information corresponding to the assistance operation to the assisted terminal; finally, the assisted terminal executes the assistance operation specified by the assisting terminal on the window according to the assistance operation information. It can be seen that, according to the implementations of the present invention, the assisting terminal may precisely and intuitively know its own task and the object that needs assistance, instead of looking for the window that needs assistance under the full screen remote assistance mode, as in the prior art, thereby avoiding looking for the real object that needs assistance and misoperation. Therefore, the implementations of the present invention can improve operation accuracy.

Moreover, in the implementations of the present invention, after designating a window that needs remote assistance, the assisting party can only see the assistance object designated by the assisted terminal, and the content unrelated to the assistance process on the desktop of the assisted terminal will not be seen by the assisting party, and therefore, the implementations of the present invention may also protect the privacy of the assisted party.

Also, in the implementations of the present invention, after a window that needs remote assistance is designated, the assisting terminal may completely and clearly display the assisted object, and a scrollbar will not appear and a problem concerning different resolution sizes will not be encountered. Therefore, the assisting terminal may also freely change the size of the window that needs assistance, and therefore, execution of remote assistance by the user is further facilitated.

As described above, merely some preferred embodiments of the present invention, and are not intended to limit the protection scope of the present invention. Any modification, equivalent replacement, improvement etc. within the spirit and principle of the present invention is included in the protection scope of the present invention.

What is claimed is:

1. A remote assistance method, wherein the method comprises:
establishing a connection between an assisted terminal and an assisting terminal through a communication protocol;
designating a window that needs assistance and sending a screenshot of the window to the assisting terminal by the assisted terminal;
displaying the screenshot of the window, executing an assistance operation on the screenshot of the window, and sending assistance operation information corresponding to the assistance operation to the assisted terminal by the assisting terminal; and
executing the assistance operation specified by the assisting terminal on the window by the assisted terminal, according to the assistance operation information.

2. The remote assistance method according to claim 1, wherein said establishing the connection between the assisted terminal and the assisting terminal through the communication protocol comprises:
establishing the connection between the assisted terminal and the assisting terminal through Network Basic Input/Output System (NETBIOS) protocol, Network Basic Input/Output System Extended User Interface (NETBEUI) protocol, Internet Packet Exchange/Sequenced Packet Exchange (IPX/SPX) protocol, or Transmission Control Protocol/Internet Protocol (TCP/IP).

3. The remote assistance method according to claim 1, wherein the method further comprises:
setting a window switching condition by the assisted terminal;
when the window switching condition is satisfied, selecting a window and designating the selected window as the window that needs assistance by the assisted terminal.

4. The remote assistance method according to claim 3, wherein said selecting the window and designating the selected window as the window that needs assistance when the window switching condition is satisfied comprises:
when the assisted terminal selects to switch to a full screen desktop, designating the full screen desktop as the window that needs assistance.

5. The remote assistance method according to claim 1, wherein
said executing the assistance operation on the screenshot of the window and sending assistance operation information corresponding to the assistance operation to the assisted terminal comprises:
executing a mouse operation and/or a keyboard operation on the screenshot of the window, and sending assistance operation information corresponding to the mouse operation and/or the keyboard operation to the assisted terminal by the assisting terminal;
wherein said executing the assistance operation of the assisting terminal on the window by the assisted terminal according to the assistance operation information comprises:
receiving by the assisted terminal the assistance operation information corresponding to the mouse operation and/or the keyboard operation, and using an Application Programming Interface (API) function to execute the mouse operation and/or the keyboard operation on the window.

6. A remote assistance system, the system including an assisting terminal and an assisted terminal, the assisted terminal and the assisting terminal establishing a connection through a communication protocol, wherein
the assisted terminal is configured to designate a window that needs assistance, and send a screenshot of the window to the assisting terminal, and execute an assistance operation specified by the assisting terminal on the window that needs assistance, according to assistance operation information sent by the assisting terminal;
the assisting terminal is configured to display the screenshot of the window, execute an assistance operation on the screenshot of the window, and send the assistance operation information corresponding to the assistance operation to the assisted terminal.

7. The remote assistance system according to claim 6, wherein the assisted terminal and the assisting terminal establishes the connection through NETBIOS protocol, NETBEUI protocol, IPX/SPX protocol or TCP/IP protocol.

8. The remote assistance system according to claim 6, wherein
the assisted terminal is configured to set a window switching condition, and when the window switching condition is satisfied, the assisted terminal selects a window and designates the selected window as the window that needs assistance.

9. The remote assistance system according to claim 8, wherein
the assisted terminal is configured to designate a full screen desktop as the window that needs assistance, when switching to the full screen desktop is selected.

10. The remote assistance system according to claim 6, wherein
the assisting terminal is configured to execute a mouse operation and/or a keyboard operation on the screenshot of the window, and send assistance operation information corresponding to the mouse operation and/or the keyboard operation to the assisted terminal;
the assisted terminal is configured to receive the assistance operation information corresponding to the mouse operation and/or the keyboard operation, and use an API function to execute the mouse operation and/or the keyboard operation on the window.

11. A remote assistance method, wherein the method comprises:
establishing a connection between an assisted terminal and an assisting terminal through a communication protocol;
designating a window that needs assistance and sending a screenshot of the window to the assisting terminal by the assisted terminal;
receiving assistance operation information sent by the assisting terminal by the assisted terminal, wherein the assistance operation information corresponds to an assistance operation executed by the assisting terminal on the screenshot of the window;
executing the assistance operation specified by the assisting terminal on the window by the assisted terminal, according to the assistance operation information.

12. The remote assistance method according to claim 11, wherein the method further comprises:
setting a window switching condition by the assisted terminal;
when the window switching condition is satisfied, selecting a window and designating the selected window as the window that needs assistance by the assisted terminal.

13. The remote assistance method according to claim 12, wherein said selecting the window and designating the selected window as the window that needs assistance when the window switching condition is satisfied comprises:
designating a full screen desktop as the window that needs assistance by the assisted terminal when switching to the full screen desktop is selected.

14. The remote assistance method according to claim 11, wherein the assistance operation executed by the assisting terminal on the screenshot of the window includes a mouse operation and/or a keyboard operation, and the assistance operation information corresponds to the mouse operation and/or the keyboard operation;
said executing the assistance operation specified by the assisting terminal on the window by the assisted terminal according to the assistance operation information includes:
receiving by the assisted terminal the assistance operation information corresponding to the mouse operation and/or the keyboard operation, and using an Application Programming Interface (API) function to execute the mouse operation and/or keyboard operation on the window.

15. A remote assistance terminal, wherein the terminal includes a connection module, a window designating module, a transceiver module and a processing module, wherein
the connection module is configured to establish a connection with an assisting terminal through a communication protocol;
the window designating module is configured to designate a window that needs assistance, and send a screenshot of the window to the transceiver module;
the transceiver module is configured to send the screenshot of the window to the assisting terminal, and receive assistance operation information sent by the assisting terminal, wherein the assistance operation information corresponds to an assistance operation executed by the assisting terminal on the screenshot of the window;
the processing module is configured to execute an assistance operation specified by the assisting terminal on the window, according to the assistance operation information.

16. The remote assistance terminal according to claim 15, wherein the terminal further includes:
a setting module, which is configured to set a window switching condition;
the window designating module is configured to select a window when the window switching condition is satisfied, and designate the selected window as the window that needs assistance.

17. The remote assistance terminal according to claim 16, wherein the window designating module is configured to designate a full screen desktop as the window that needs assistance when the assisted terminal selects to switch to the full screen desktop.

18. The remote assistance terminal according to claim 15, wherein the assisting terminal executes an assistance operation comprising a mouse operation and/or a keyboard operation on the screenshot of the window, and the assistance operation information corresponds to the mouse operation and/or the keyboard operation;
the transceiver module is configured to receive the assistance operation information corresponding to the mouse operation and/or the keyboard operation;
the processing module is configured to use an Application Programming Interface (API) function to execute the mouse operation and/or the keyboard operation on the window.
